(19) United States
(12) Patent Application Publication
(10) Pub. No.: US 2003/0033911 A1
(43) Pub. Date: Feb. 20, 2003

(54) Lug nut buster tm

(76) Inventors: Leonard Maurice Averett, Elkridge, MD (US); Calvin Irick, Owings Mill, MD (US)

Correspondence Address: LEONARD MAURICE AVERETT, 8021 SOMERVILLE LANE, ELKRIDGE, MD, 21075, US

(21) Appl. No.: 09/931,898

(22) Filed: Aug. 20, 2001

(51) Int. Cl. B25B 23/16

(52) U.S. Cl. 81/177.2

(57) ABSTRACT

The Lug Nut Buster™, is an adapter used for the removal of over tightens automobile tire lug nuts. It is painted 30-inch galvanized steel pipe. The center of the bar is hollow enabling it to fit over the standard lug wrench. The diameter is of the bar is ½ inch. The tool uses the principal of leverage to enable individual to loosen any lug nut. On one end of the bar is a 4¾ inch black gel grip.

Of which the following is a specification, reference being had to the accompany drawing forming a part thereof.

### BRIEF SUMMARY OF THE INVENTION

The Lug Nut Buster™ (a lug nut wrench adapter) is an instrument that fits over the Lug Wrench, which gives the correct leverage to enable the lug nut to be loosened.

### BRIEF DESCRIPTION OF THE DRAWINGS

FIG. 1 is a top plan view of the Lug Nut Buster™ (Lug Nut Wrench Adapter)

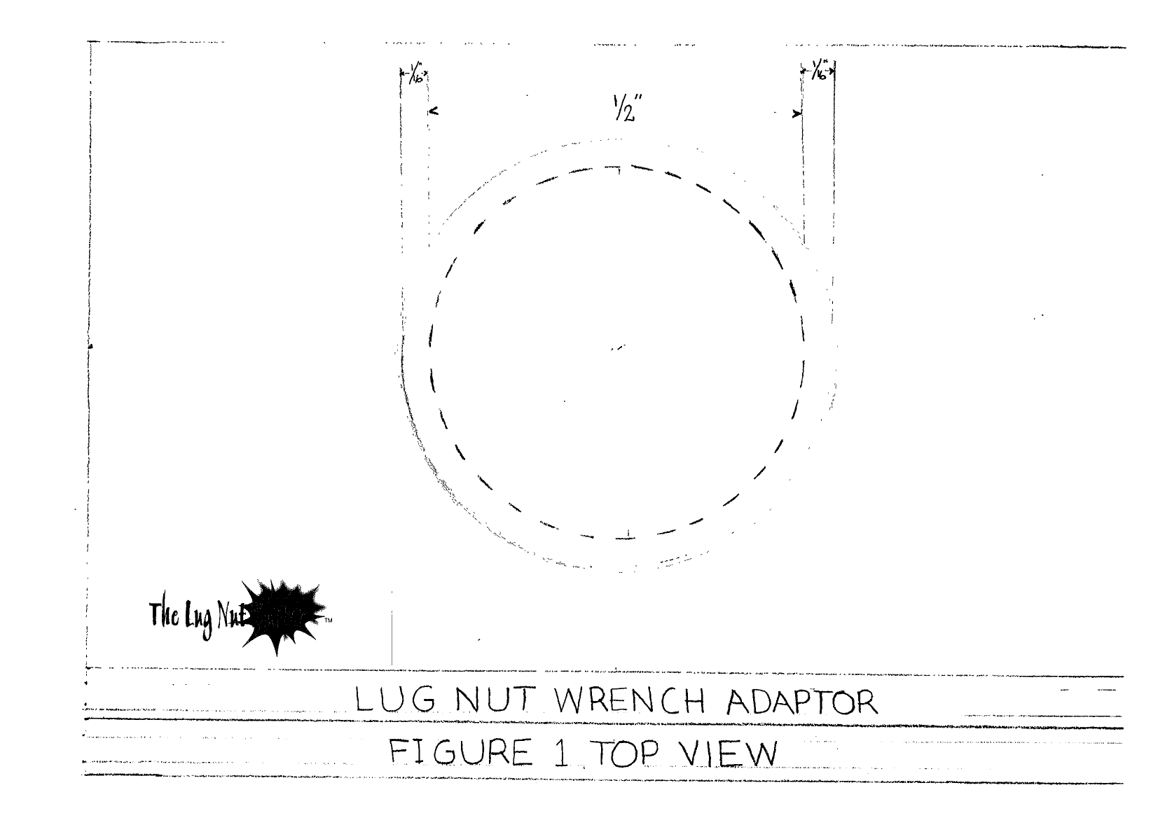

FIG. 2 is a bottom plan view of the Lug Nut Buster™ (Lug Nut Wrench Adapter)

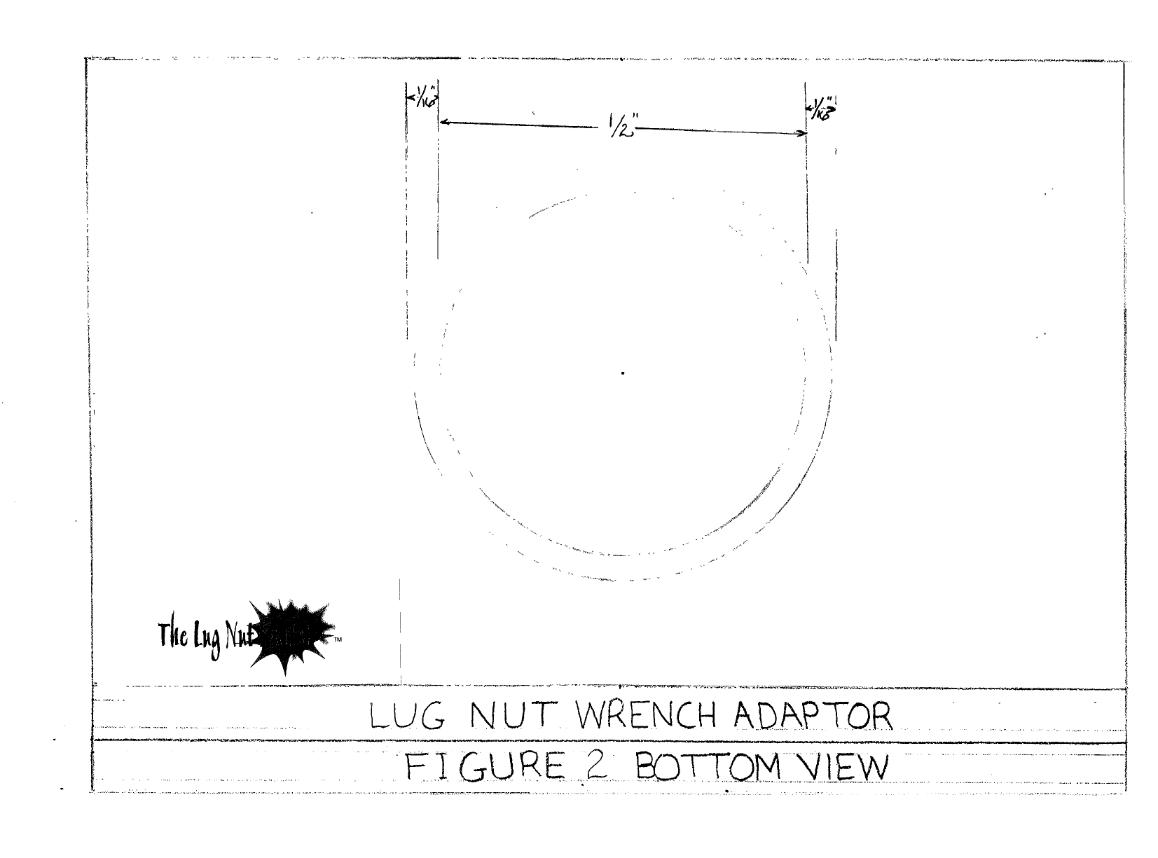

FIG. 3 is a front plan view of the Lug Nut Buster™ (Lug Nut Wrench Adapter).

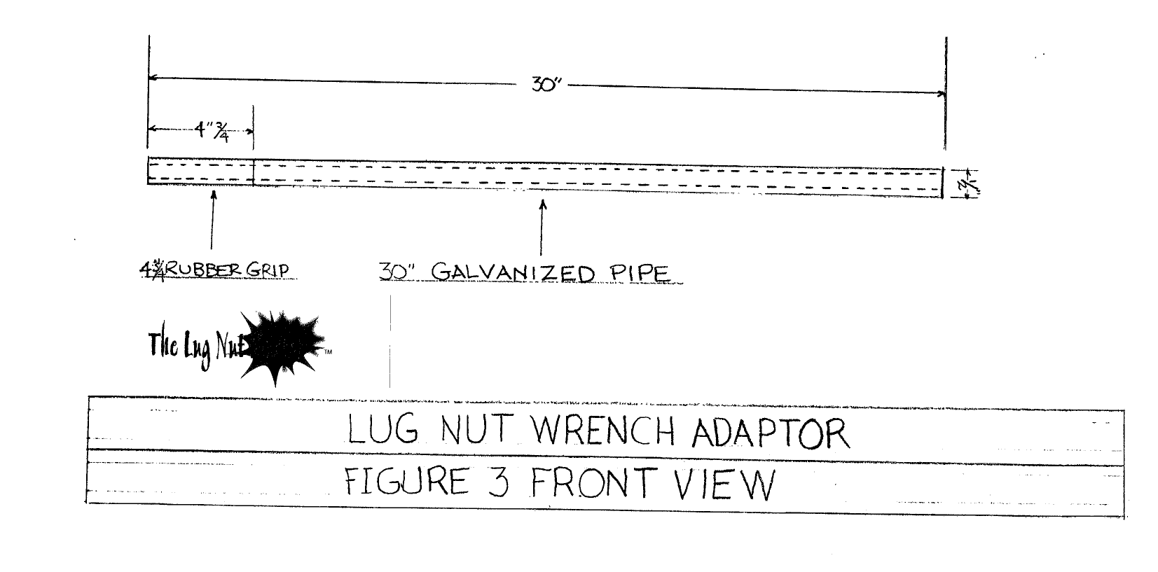

We claim:

1. The ornamental utility for a Lug Nut Buster™ (Lug Nut Wrench Adapter as shown and described.
